(19) United States
(12) Patent Application Publication
(10) Pub. No.: US 2025/0134009 A1
(43) Pub. Date: May 1, 2025

(54) PLANT HOLDER

(71) Applicant: Floriate Holding B.V., Lutjebroek (NL)

(72) Inventor: Franciscus Gerardus Timmerman, Lutjebroek (NL)

(21) Appl. No.: 18/681,944

(22) PCT Filed: Dec. 7, 2022
(86) PCT No.: PCT/EP2022/084880

§ 371 Date: Feb. 7, 2024

(30) Foreign Application Priority Data
Dec. 14, 2021 (NL) 1044236

(51) Int. Cl. A01G 9/02

(52) U.S. Cl. CPC A01G 9/024

(57) ABSTRACT

A pot (100) for holding a plant (200). The pot (100) is configured with an opening for the plant (200) which can be oriented in various directions by rotating an upper body shell (101) relatively to a lower body shell (102). The bodyshells are arranged for being rotated relative to each other around a rotational axis (1002), and the opening is positioned off-centered of the rotational axis. The body shells are preferably hemispheres and the enclosure is substantially spherical when the bodyshells are connected. Configurations (100a-e) of pots (100A, 100C) suspended beneath each other are possible without putting stress on the pots (100A, 100C) by using a chain (300) running through the pots (100A, 100C). The pots (100A, 100C) may be mounted on a wall (400) in various orientations and positions.

### TECHNICAL FIELD

The invention relates to plant pots. More particular the invention relates to plant pots which provide flexibility in configuration.

### BACKGROUND

Plant holders come in a lot of varieties. Most commonly used holders comprise a cylinder or a tapered round container with an open upper side in which soil and one or more plants may be placed. Similar holders are designed for flowers.

There are mainly three challenges in designing a good holder for a plant.

The first challenge is to provide an opening in the holder (hereinafter referred to as “pot”), large enough to easily put soil in the pot. Often these pot should also accommodate a holder which is already holding a plant with oil when bought in a shop, so a large as possible opening is often preferred. A too large opening is, however, not desirable, because soil may be spilled over the edge or the plant may lack support and loose stability.

The second challenge is to provide a means for watering the plant without the need to handle the plant itself too much and without spoiling water. Usually, plants in pots are watered by casting water directly on the soil. The area with soil around the plant is usually the preferred area to poor the water on the soil. Especially when the soil is already much dried out, this often leads to spilling of water, as the water is not immediately sucked up by the soil.

A third challenge is to design a pot which provides flexibility in orientation of the plant. Plants are usually of two types: a first type with a relatively firm stem, which usually grows in an upright direction and a second type which comprises a hanging plant which usually grows over the edge of the pot downwards.

A fourth challenge is to design a pot which allows for combining plants and pots in various configurations. A regular pot usually only allows to combine pots by placing them next to each other.

There are some solutions which aim to meet one or more of the above challenges.

South-Korean Patent application KR 10-2020-0014607, for example, is summarized as a flower ball for landscaping in which flowers can be put different angle and direction. The ball has a top soil injection hole and a plurality of planting holes are formed on the surface thereof and has an inner space where top soil is accommodated. A tube-shaped water tank is installed in the center of the planting portion with a closed bottom and an open top. A wick is inserted into the water tank with one end in contact with the bottom surface of the water tank and the other end facing the one end is drawn out of the water tank, so that the wick is disposed inside upper part of the planting portion.

### DISCLOSURE OF INVENTION

It is an object of the present invention to provide a pot for holding a plant, which allows for a flexible orientation of the plant. It is a further object of the invention to provide a pot which facilitates easy watering of the plant and which is suitable for stacking with multiple pots. It is yet a further object of the invention to provide a pot which is easy to produce, to store, to transport and to handle.

The object is realized by the following clauses and further embodiments.
1. A pot for holding one or more plants, the pot configured with an opening arranged for a plant of the one or more plants to stick or to grow out of the pot, characterized in that,
   the pot comprises an enclosure which comprises an upper bodyshell and a lower bodyshell which are arranged for being connected together to form an enclosure for the plant, whereby:
      the upper bodyshell comprises the opening,
      the bodyshells are arranged for being rotated relative to each other around a rotational axis, and
      the opening is positioned off-centered of the rotational axis.
2. The pot according to clause 1, characterized in that the bodyshells are hemispheres and the enclosure is substantially spherical when the bodyshells are connected.
3. The pot according to any one of the preceding clauses, characterized in that the lower bodyshell comprises a bottom center point, whereby the lower body shell is arranged for being positioned with the bottom center point positioned substantially at the lower side of the lower body shell, in such a manner that the rotational axis is tilted relatively to the vertical axis of the enclosure.
4. The pot according to any one of the preceding clauses, characterized in that the lower bodyshell comprises an attachment means positioned at the bottom center point and arranged for attaching a rod and fixing said rod substantially in the vertical axis.
5. The pot according to clause 4, characterized in that the rod is configured with a first fastening means at the top end, said fastening means arranged for suspending the enclosure.
6. The pot according to clause 4 or 5, characterized in that the attachment means of the lower bodyshell comprises a hole configured for the rod to be inserted at least partly, whereby the rod is configured with a second fastening means at the lower end, said second fastening means arranged for suspending an object, such as a second enclosure below the pot.
7. The pot according to any one of the preceding clauses, characterized in that the upper bodyshell comprises a third fastening means arranged for suspending the enclosure.
8. The pot according to any one of the clauses 4-7, characterized in that the attachment means is arranged for attaching a watering means arranged for guiding water from into the enclosure.
9. The pot according to clause 8, characterized in that the watering means is configured as a tube with an opening at the top and one or more holes in the wall of the tube.
10. The pot according to any one of the clauses 4-9, characterized in that the attachment means is arranged for attaching a water level indicator, which comprises a float with an extending indicator sticking out of the pot indicating the water level in the pot when positioned at a height in correspondence with the upward water pressure of the water in the pot on the float.
11. The pot according to any one of the clauses 8-10, characterized in that the rod or the watering means are configured with a thread, and the attachment means is configured with a matching thread for screwing the rod or the watering means respectively together.
12. The pot according to any one of the clauses 4-11, characterized in that the attachment means is configured for selectively attaching the rod or the watering means.
13. The pot according to any one of the clauses 4-12, characterized in that the rod is configured as a tube with open ends, whereby the hollow inside of the tube is configured for a guiding a cable, such as a chain or a rope.
14. The pot according to any one of the preceding clauses, characterized in that the pot is arranged for holding soil, hydro granules and/or water.
15. The pot according to any one of the preceding clauses, characterized in that the opening is configured as a circle, flower, or a configuration of multiple orifices.
16. The pot according to any one of the preceding clauses, characterized in that the upper and/or the lower bodyshell are arranged for being nested for storage or transport.
17. The pot according to any one of the preceding clauses, characterized in that the upper and lower bodyshell are provided with a thread configured for screwing the upper and the lower body shells together.
18. The pot according to any one of the preceding clauses, characterized in that the pot is configured with a fastening means arranged for mounting the pot to a wall.

### BRIEF DESCRIPTION OF THE DRAWINGS

The figures show views of embodiments in accordance with the present invention.

FIG. 1a shows a side view of embodiment of the invented pot.

FIG. 1b shows a front view of the pot.

FIG. 1c shows a perspective view showing part of the inside of the pot.

FIG. 1d shows a perspective view showing a bottom section of the pot.

FIG. 1e shows a side view of the pot with a rotated upper body shell of the pot.

FIG. 1f shows a perspective view of the pot with a rotated upper body shell of the pot.

FIG. 2 shows a configuration with a first pot and a second pot hanging beneath the first pot.

FIG. 3 shows a configuration with a first, second and third pot mounted on a wall.

### DETAILED DESCRIPTION

The invention is now described by the following aspects and embodiments, with reference to the figures. For quick reference, a list of the references is shown below.
100 An embodiment of the invented pot
100a-e Pots in various configurations
101 Upper bodyshell
102 Lower bodyshell
103 circumferential section
110 concave section in lower bodyshell 102
114a rod
114b tube
115 first fastening means
116 second fastening means
117 top opening of tube 114b
118 bottom opening of tube 114b
120 hollow
121 top opening
124 attachment means
200 plant
201 second plant
300 chain
400 wall
401 fastening means with screw and bold
402 fastening means with hook
403 fastening means with double sided tape or glue
1001 rotating direction
1002 vertical axis
1002a,b center points on the convex surface of body shell 101,102
1003 off-set axis

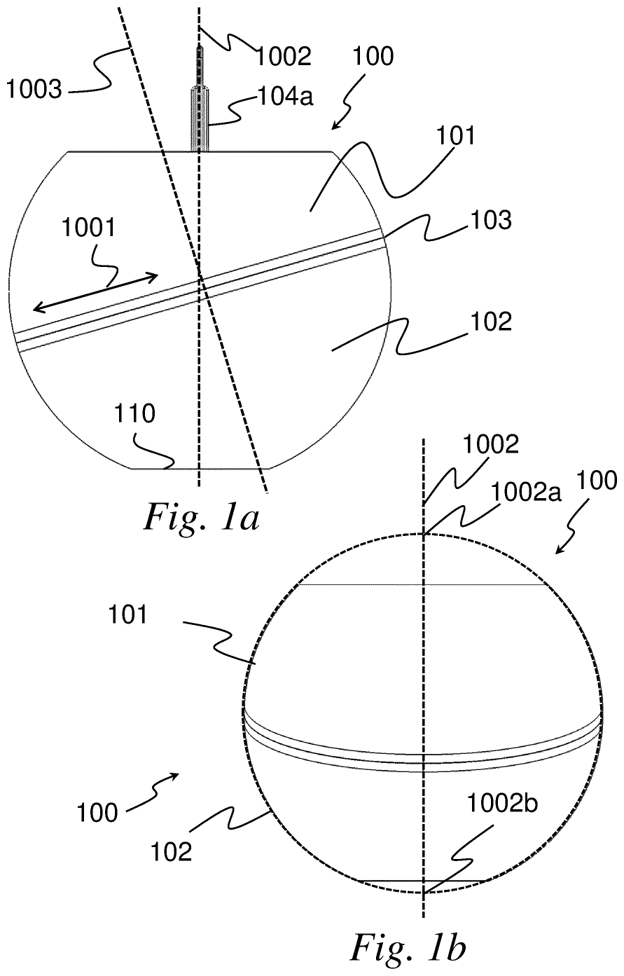

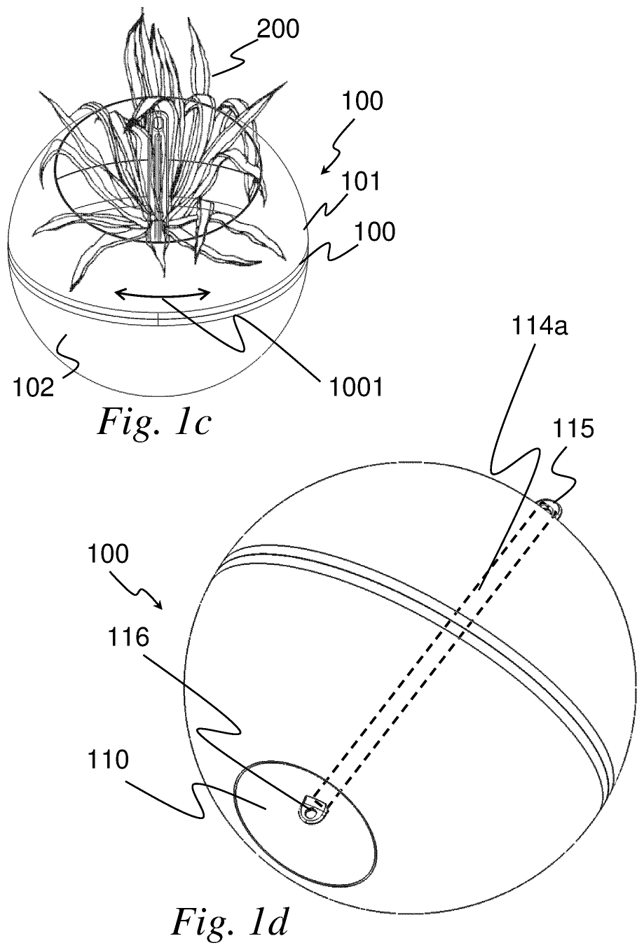

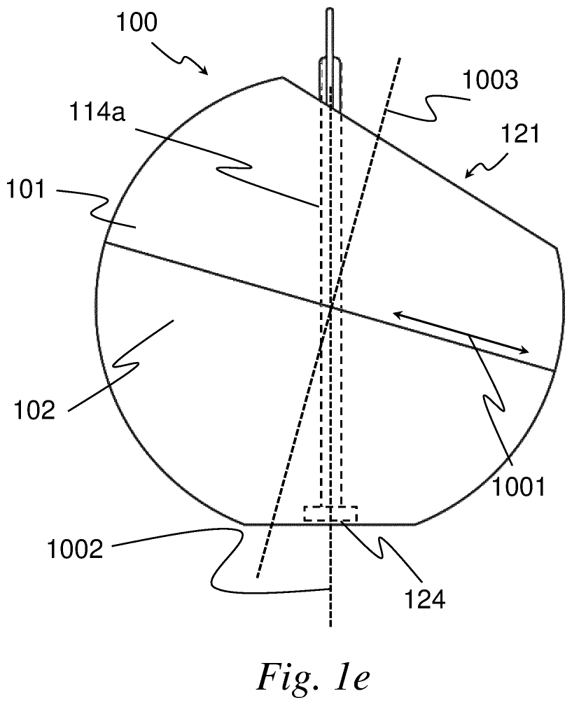

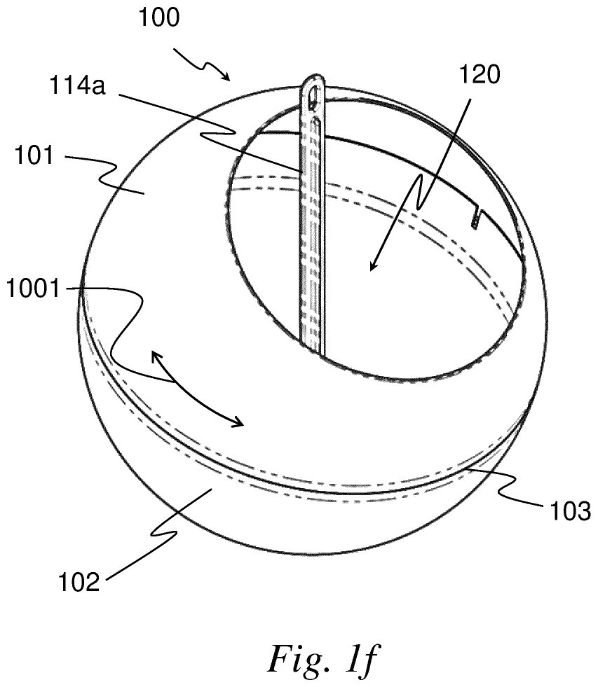

FIG. 1a shows a perspective view of embodiment of the invented pot 100. The pot 100 preferably comprises an upper body shell 101 and a lower bodyshell 102. The bodyshells are substantially hollow (see FIG. 1f for hollow 120). When put together at the circumferential section 103, the body shells form an enclosure. For the purpose of understanding, the following wording is used. For illustration we refer to FIG. 1b.

FIG. 1b shows a front view of the pot 100, wherein a vertical axis is shown as dotted line 1002. Vertical axis 1002 runs through pot 200 from center 1002a to the center 1002b. The virtual top center 1002a,b of the upper or lower bodyshell respectively is the center point on the convex surface of the hemisphere, in other words the highest point of the hemisphere when the hemisphere would be placed on a flat surface with the circumferential section 103 on a flat surface. Virtual bottom center 1002b is at the opposite side of virtual top center 1002a. To illustrate the virtual position of the center points 1002a,b, dotted lines indicate the shape as if it were not cut off as in the exemplary pot 100. Vertical axis 1002 runs through pot 200 from center 1002a to center 1002b.

FIG. 1c shows a perspective view showing a part of the inside of the pot 100. As an illustration of a practical implementation a plant 200 is included in the figure. Plant 200 may be oriented in a desired direction by rotating upper bodyshell 101 in directions of arrow 1001.

FIG. 1d shows a perspective view showing a bottom section of the pot 100. Rod 114a runs from top to bottom. Rod 114 comprises a first fastening means 115 at the top and a second fastening means 116 at the bottom. Rod 114a may also only be provided with one fastening means at either side. Rod 114a may be fastened to the bottom 110 which may comprise a concave section in lower bodyshell 102. Being concave bottom 110 provides a recess to hide fastening means 116, which comes in handy, when pot 100 is placed flat on a surface on bottom 110. By hiding fastening means 116 in this manner, the shape of pot 100 remains its aesthetical attractiveness.

Rod 114a may also serve the purpose of taking off the stress on pot 100 when other items such as a second pot are attached to the rod. Pull or push forces are led to bottom 110 of pot 100, and in particular to the area around second fastening means 116.

FIG. 1e shows a side view of the pot with a rotated upper body shell 101 of the pot 100. Here, it is further illustrated that the rotation axis 1003 is off set relative to vertical axis 1002, which provides the unique feature that rotating upper bodyshell 101 in direction 1001 changes the orientation of top opening 121.

FIG. 1f shows a perspective view of the pot 100 with a rotated upper body shell 101 of the pot 100. The figure illustrates the rotated position further. Instead of rod 114a, a tube may be configured which allows watering of the plant. The tube may be provided with a water level indicator indicating when the plant needs to be watered. A tube of this kind may also be provided with side holes which disperse water evenly in the soil of the pot. Watering may be done by inserting water from the top of the tube. The watering may also be done by an automatic watering system.

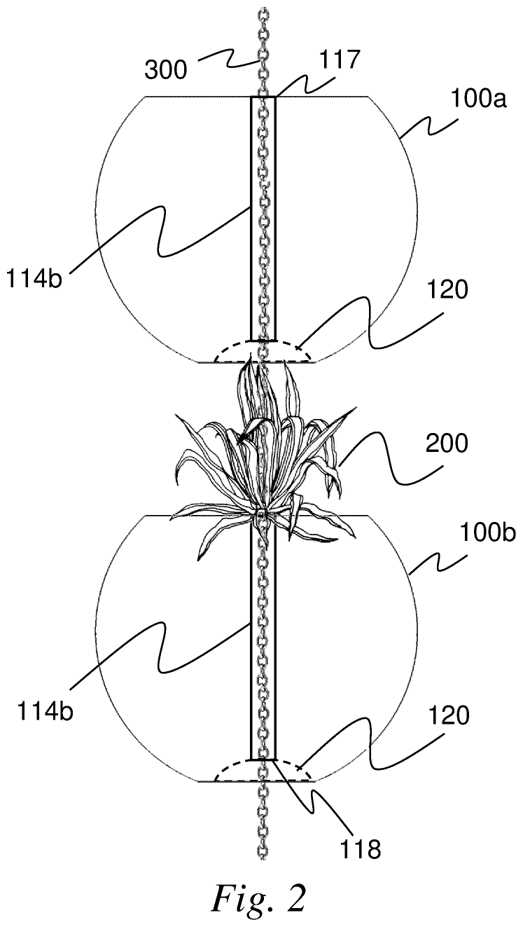

FIG. 2 shows a configuration with a first pot 100a and a second pot 100b hanging beneath the first pot 100a. Instead of a rod 114a, a tube may be configured in pot 100. A chain runs through tube 114b form the top 117 to the bottom 118 of the first and second pot. For this purposes the connection of the rod 114a or tube 114b may be such that interchangeability is provided o the rod 114a and tube 114b. For example, tube 114b may be screwed to bottom 110. Bottom 110 is provided with a hole in this case to let chain 300 run through pot 100a. Chain 300 may be fastened to pot 100a at the top or at the bottom.

The advantage of this construction is that second pot 100b is suspended by 300 and not by pot 100a. The relieves stress on pots 100a,b when multiple pots are suspended beneath each other.

With this configuration all kinds of combinations of pots may be provided, such as for forming a wall of plants.

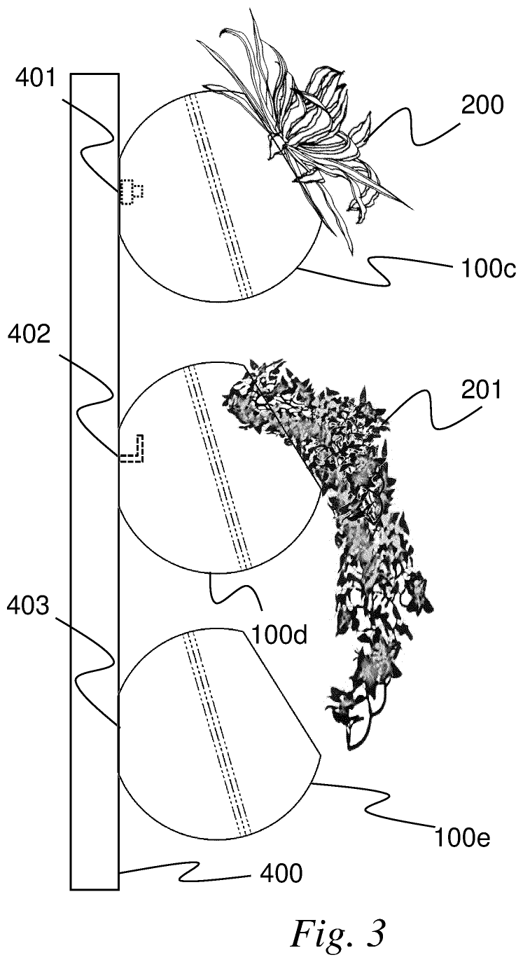

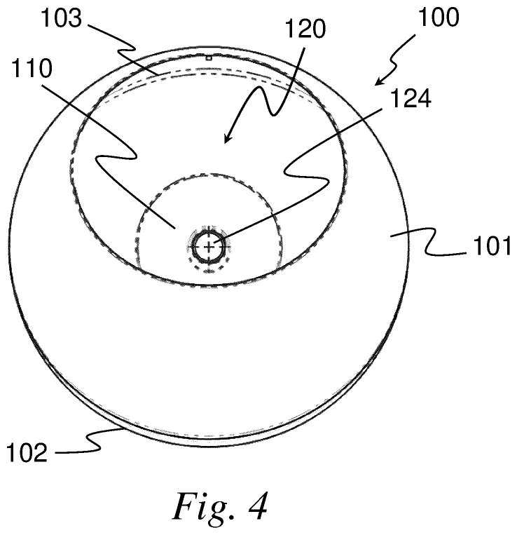

FIG. 3 shows a configuration with a first pot 100c, second pot 100d and third pot 100e mounted on a wall 400. Pots 100c,d,e may be provided with means for attaching them to a wall and still the orientation of the openings may be changed. Plants 200, 201 may be put in the pots for decorative purposes.

Beside decoration, the configuration provides a very efficient way to cover a wall, such as an office wall with plants. Especially plants with air purification characteristics will improve the living and working environment considerably in this manner. The orientation of the openings of the pot make watering easier. Fastening to a wall 400 may for example be done with a screw and bold construction 401, a hook 402 or by using double sided tape or glue 403.

It should be noted that the above-mentioned embodiments illustrate rather than limit the invention, and that a person skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The term “and/or” includes any and all combinations of one or more of the associated listed items. The article “a” or “an” preceding an element does not exclude the presence of a plurality of such elements. The article “the” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. A pot for holding one or more plants, the pot configured with an opening arranged for a plant of the one or more plants to stick or to grow out of the pot, wherein
the pot comprises an enclosure which comprises an upper bodyshell and a lower bodyshell which are arranged for being connected together to form an enclosure for the plant, whereby:
the upper bodyshell comprises the opening,
the bodyshells are arranged for being rotated relative to each other around a rotational axis, and
the opening is positioned off-centered of the rotational axis.

2. The pot according to claim 1, wherein the bodyshells are hemispheres and the enclosure is substantially spherical when the bodyshells are connected.

3. The pot according to claim 1, wherein the lower bodyshell comprises a bottom center point, whereby the lower body shell is arranged for being positioned with the bottom center point positioned substantially at the lower side of the lower body shell, in such a manner that the rotational axis is tilted relatively to the vertical axis of the enclosure.

4. The pot according to claim 1, wherein the lower bodyshell comprises an attachment means positioned at the bottom center point and arranged for attaching a rod and fixing said rod substantially in the vertical axis.

5. The pot according to claim 4, wherein the rod is configured with a first fastening means at the top end, said fastening means arranged for suspending the enclosure.

6. The pot according to claim 4, wherein the attachment means of the lower bodyshell comprises a hole configured for the rod to be inserted at least partly, whereby the rod is configured with a second fastening means at the lower end, said second fastening means arranged for suspending an object, such as a second enclosure below the pot.

7. The pot according to claim 1, wherein the upper bodyshell comprises a third fastening means arranged for suspending the enclosure.

8. The pot according to claim 4, wherein the attachment means is arranged for attaching a watering means arranged for guiding water from into the enclosure.

9. The pot according to claim 8, wherein the watering means is configured as a tube with an opening at the top and one or more holes in the wall of the tube.

10. The pot according to claim 4, wherein the attachment means is arranged for attaching a water level indicator, which comprises a float with an extending indicator sticking out of the pot indicating the water level in the pot when positioned at a height in correspondence with the upward water pressure of the water in the pot on the float.

11. The pot according to claim 4, wherein the rod is configured with a thread, and the attachment means is configured with a matching thread for screwing the rod together.

12. The pot according to claim 11, wherein the attachment means is configured for selectively attaching the rod.

13. The pot according to claim 4, wherein the rod is configured as a tube with open ends, whereby the hollow inside of the tube is configured for a guiding a cable, such as a chain or a rope.

14. The pot according to claim 1, wherein the pot is arranged for holding soil, hydro granules and/or water.

15. The pot according to claim 1, wherein the opening is configured as a circle, flower, or a configuration of multiple orifices.

16. The pot according to claim 1, wherein the upper and/or the lower bodyshell are arranged for being nested for storage or transport.

17. The pot according to claim 1, wherein the upper and lower bodyshell are provided with a thread configured for screwing the upper and the lower body shells together.

18. The pot according to claim 1, wherein the pot is configured with a fastening means arranged for mounting the pot to a wall.
